(19) United States
(12) Patent Application Publication
(10) Pub. No.: US 2009/0077149 A1
(43) Pub. Date: Mar. 19, 2009

(54) ASYNCHRONOUS SAMPLING RATE CONVERSION

(75) Inventors: Ryo Tsutsui, Ibaraki (JP); Lars Risbo, Hvalsoe (DK)

Correspondence Address: TEXAS INSTRUMENTS INCORPORATED, P O BOX 655474, M/S 3999, DALLAS, TX, 75265, US

(73) Assignee: TEXAS INSTRUMENTS INCORPORATED, Dallas, TX (US)

(21) Appl. No.: 12/210,794

(22) Filed: Sep. 15, 2008

Related U.S. Application Data
(60) Provisional application No. 60/972,445, filed on Sep. 14, 2007.

(51) Int. Cl. G06F 17/17

(52) U.S. Cl. 708/313

(57) ABSTRACT

Asynchronous sampling rate converter using multistage oversampling with final stage polyphase filter coefficients approximated by polynomials of the filter index. The approximation polynomial coefficients occupy smaller memory than the polyphase filter coefficients being approximated.

### CROSS-REFERENCE TO RELATED APPLICATIONS

This application claims priority from U.S. provisional patent application No. 60/972,445, filed Sep. 14, 2007. The following co-assigned, copending patent applications disclose related subject matter: application Ser. No. 11/371,597, filed Mar. 9, 2006. All of which are incorporated herein by reference.

### BACKGROUND OF THE INVENTION

The invention relates to digital signal processing, and more particularly to circuitry and methods for conversion of sampling rates of digitally sampled data.

Audio systems currently are required to handle data with various sampling rates, from low rates found in many .WAV files such as 8 kHz to high rates of consumer audio equipment such as 48 kHz. Audio is a key feature of PC multimedia with system requirements approaching those of consumer high fidelity systems for a fraction of the cost. For example, the PC 2001 specification sets high quality audio requirements to play out audio streams at 44.1 and 48 kHz rates. A hardware vendor may choose to supply a codec that only supports 48 kHz. In this case, sample rate conversion between 44.1 and 48 kHz is needed.

Of course, sampling rate conversion for integer ratio sampling rates can be performed by the steps of interpolation, lowpass filtering, and decimation. However, filters for a digital sampling rate conversion (SRC), where input and output sampling rates have a very large least common multiple, or the conversion ratio is irrational or slowly changing can be cumbersome. The irrational or slowly changing case is typically called an asynchronous sampling rate conversion (ASRC), and a well-known conversion method oversamples an input signal, converts it to a continuous signal by zeroth-order hold (ZOH), and then samples the continuous signal at the output sampling period. FIG. 1 illustrates such a converter.

In order to sufficiently reduce ZOH distortion, the oversampling ratio has to be very large; some researchers claim the ratio of 2¹⁶ is adequate to achieve 16-bit accuracy. The problem that arises is that a large oversampling ratio requires a large number of filter coefficients. In order to efficiently reduce the memory storage for the filter coefficients, methods have been proposed that make use of multistage implementations of FIR filters; for example, see cross-reference patent application Ser. No. 11/371,597. However, the ROM size reduction by such methods is still not sufficient because the size should be proportional to the oversampling ratio of the second stage oversampler. On the other hand, Ries, A Class of Sampling Rate Converters with Interesting Properties, Audio Engineering Society 114th Convention, convention paper 5827 (2003), introduced a method that first oversamples an input digital sample stream by a factor of M (e.g., inserts M−1 samples equal to 0 between pairs of input samples plus lowpass filters (Kaiser filter) to eliminate images), and then performs a sampling-theorem type reconstruction using these oversamples but with sin c( ) replaced by an optimal finite-duration kernel derived from a B-Spline and its derivatives. This reconstruction can be calculated in run-time because the kernels are finite-duration. This significantly reduces ROM size while enabling high oversampling ratios because the kernels are piecewise polynomials. However, an audio system using such reconstruction would suffer poor sound quality due to the frequency characteristics of the B-Spline filter.

However, the known sampling rate converters need further improvements.

### SUMMARY OF THE INVENTION

The present invention provides a digital sampling rate converter and filter design method using polynomial approximations for a polyphase filter as part of a multistage oversampling filter.

### BRIEF DESCRIPTION OF THE DRAWINGS

FIG. 1 is a block diagram of a sampling rate converter.

FIGS. 2A-2E are waveforms for sampling rate conversion.

FIGS. 3-4 show two-stage filtering and equivalent.

FIGS. 5A-5D illustrate two-stage filtering spectra.

FIG. 6 is a block diagram of a second stage filter.

FIGS. 7-13 show frequency responses of various experimental filters.

FIG. 14 is an attenuation-droop curve.

### DESCRIPTION OF THE PREFERRED EMBODIMENTS

### 1. Overview

Preferred embodiment methods provide digital Asynchronous Sample Rate Conversion (ASRC) with two-stage oversampling using polynomial approximations in the second stage polyphase filtering. Indeed, with a first stage oversampling filter prescribed, a design method for the second oversampling filter first establishes a prototype of an optimum oversampling polyphase filter that minimizes a norm of the error in the frequency domain. Then the target sequence for the prototype is approximated by polynomials. Since the input signal to the second stage oversampler has been bandlimited by the first stage oversampler, lower degree polynomials are sufficient for the approximation.

For the approximation, two methods, namely two-step and direct approximation, are presented. A modification to the preferred filter design is also presented that improves the stop-band attenuation level by allowing droop in the pass-band.

Analogous to conventional polynomial interpolators such as Lagrange and B-Spline, the preferred embodiment polynomial-derived polyphase oversampling filter enables any large oversampling ratio, up to infinity. This gets rid of ZOH distortion. The difference is that the preferred embodiment filter outperforms those conventional interpolators in terms of frequency response, which is also confirmed through experiments.

Preferred embodiment systems (e.g., digital audio players, personal computers with multimedia capabilities, et cetera) perform preferred embodiment methods with any of several types of hardware: digital signal processors (DSPs), general purpose programmable processors, application specific circuits, or systems on a chip (SoC) such as combinations of a DSP and a RISC processor together with various specialized programmable accelerators and variable length coding (VLC). For example, the 55× family of DSPs from Texas Instruments have sufficient power. A stored program in an onboard or external (flash EEPROM or FRAM) could implement the signal processing.

### 2. Sampling Rate Conversion

In order to describe the preferred embodiments, we first consider the “analog interpretation” of sampling rate conversion.

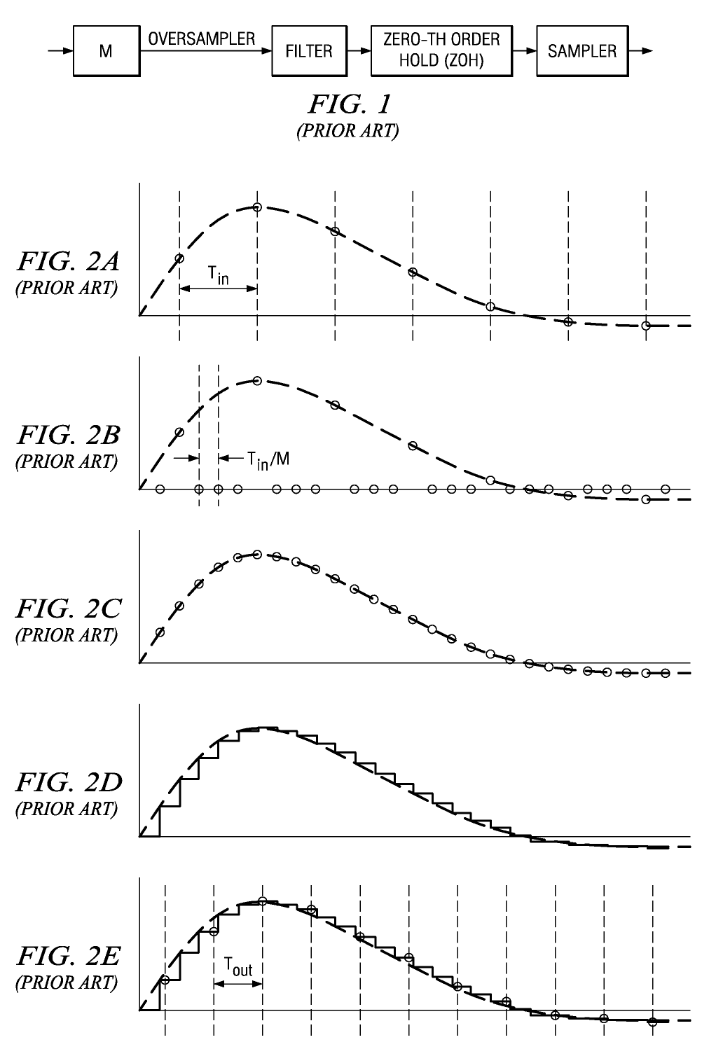

FIG. 1 is a functional block diagram of the rate conversion processing, and FIGS. 2A-2E show the signal shapes after each processing step in FIG. 1. We assumed that we have the original continuous signal (dotted curve in FIG. 2A) whose bandwidth is limited so that it satisfies the sampling theorem with regards to the both of input and output sampling periods. The discrete input signal (circle plots in FIG. 2A) is just a time-discretized sequence of the continuous signal. To oversample the input signal by the ratio M(M=4 in the figure), we first insert M−1 zeroes between each samples (FIG. 2B), and then we obtain a smooth oversampled signal using an oversampling filter (FIG. 2C). Note that, more specifically, the oversampling filter plays a role of reducing the aliasing components that were generated by the zero-insertion. ZOH is performed to simulate a pseudo-continuous signal out of the oversampled signal (FIG. 2D). Sampling the pseudo continuous signal at the output sampling period gives the output signal (FIG. 2E). In FIG. 2E, it is found that the output signal exhibits visible errors with regards to the original continuous signal, which can be interpreted as a ZOH distortion. We can guess that much higher oversampling ratio than just M=4 would be necessary in order to obtain more accurate results. Actually, some assert that an oversampling ratio of 2¹⁶ is necessary to achieve 16-bit accuracy.

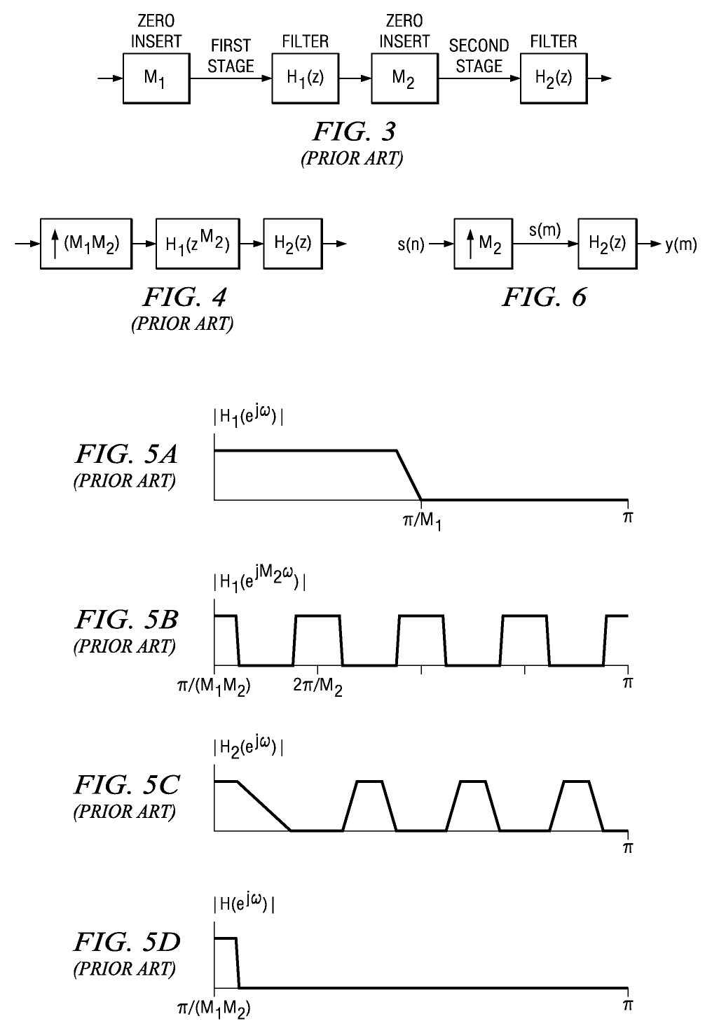

FIG. 3 shows the block diagram of the two-stage implementation of the oversampler, where the overall oversampling ratio M is calculated as M=M₁M₂. In order to make it easy to analyze the behavior of FIG. 3, we consider the equivalent block diagram shown in FIG. 4. In the figure, we insert M₁M₂−1 zeroes between successive input samples, and then process with an oversampling filter that is represented by the transfer function

H(z)=H₁(z^{M}^{₂})H₂(z)

can be understood as a class of interpolated FIR (IFIR) filters, where H₁(z) and H₂(z) are called the bandedge shaping and the masking filters, respectively. FIGS. 5A-5D show frequency responses of bandedge shaping and masking filters for oversampling. From FIG. 3, the first stage oversampling filter H₁(z) has to have the cut-off around the frequency ω=π/M₁. H₁(z^{M}^{₂}) is the zero-inserted version of H₁(z), whose cut-off is shifted to ω=π/(M₁M₂). A benefit from zero-insertion in H₁(z) is that the transition band is narrowed by the factor of M₂. The zero-insertion, however, generates M₂ images, which can be suppressed by the valleys of the masking filter H₂(z). As a result, we obtain the entire frequency response of H(z) defined by the equation as shown in the bottom graph FIG. 5D. Crochiere and Rabiner, Multirate Digital Signal Processing (Prentice-Hall 1983), chapter 5 has a discussion of multistage interpolation (and decimation) filter design.

### 3. Second Stage (Masking) Filter Prototype

The preferred embodiment methods provide for masking filter H₂(z) design with efficient ROM size for coefficient storage. Note that H₁(z) can be any filter, whether FIR or IIR, as long as it has a proper low-pass characteristic as shown in FIG. 5A. Under this assumption, we first derive the prototype of the second stage oversampling filter in a standard manner, and then utilize it for the preferred embodiment polynomial oversampling filter design.

### Ideal Response

FIG. 6 shows the signal flow for the second stage of the oversampling converter. In the figure, s(n) is the output from the previous stage oversampling filter H₁(z), and input to the second stage oversampling. As can be seen in FIG. 5A, its bandwidth must be limited to within π/M₁. The zero-inserted signal s′(m) is given as:

$$\begin{matrix}{s}^{′} ( m ) = s ( n ) if m = {nM}_{2} \\ = 0 otherwise\end{matrix}$$

Let H₂(z) be a non-causal FIR filter with length 2M₂L. Also, let the impulse response of H₂(z) be h₂(m) for m=−LM₂, −LM₂+1, . . . , LM₂−1. Then the output signal y(m) is given as:

y(m)−Σ_{-LM}_{₂}_{≦k≦LM}_{₂}₋₁s′(m−k)h₂(k).

Apply index mapping: m=nM₂+ρ with n=−L, . . . , L−1 and ρ=0, 1, 2, . . . , M₂−1; and use the definition of s′(m) as mostly zeroes to get the polyphase structure of the filter:

$$\begin{matrix}y ( {nM}_{2} + ρ ) = {\sum }_{- L \leq l \leq L - 1} s ( n - l ) {h}_{2} ( {lM}_{2} + ρ ) \\ = {\sum }_{- L \leq l \leq L - 1} s ( n - l ) {g}_{ρ} ( l )\end{matrix}$$

where g_{ρ}(l)=h₂(lM₂+ρ) for −L≦l≦L−1. The g_{ρ}(l) can be said to form a set of length-2L polyphase filters that are obtained by downsampling h₂(m).

As will be shown, the design problem for h₂(m) can be reduced to the easier problem of designing individual g_{ρ}(l). To do this, we next derive the relationship of frequency response between h₂(m) and the g_{ρ}(l).

Taking the z-transform of g_{ρ}(l) and changing summation index gives:

$$\begin{matrix}{G}_{ρ} ( z ) = {\sum }_{- L \leq l \leq L - 1} {g}_{ρ} ( l ) {z}^{- l} \\ = {\sum }_{- L \leq l \leq L - 1} {h}_{2} ( {lM}_{2} + ρ ) {z}^{- l} \\ = {\sum }_{- {LM}_{2} \leq k \leq {LM}_{2} - 1} {h}_{2} ( k ) q ( k ) {z}^{- ( k - ρ ) / {M}_{2}}\end{matrix}$$

where q(k)=δ_{k,1M}_{₂}_{+ρ} reflects the index change from l to k. Then q(k) expressed in terms of its M₂-point DFT is:

q(k)=(1/M₂)Σ_{0≦λ≦M}_{₂}₋₁e^{-j2πλ(k-ρ)/M}^{₂}

Substituting this expression for q(k) in the above, factoring the exponentials, and switching order of summation gives:

G_{ρ}(z)=(1/M₂)Σ_{0≦λ≦M}_{₂}₋₁e^{j2πλρ/M}^{₂}z^{ρ/M}^{₂}H₂(e^{j2πλ/M}^{₂}z^{1/M}^{₂})

The frequency response of g_{ρ}(l) can be seen by setting z=e^{jω} in the foregoing:

G_{ρ}(e^{jω})=(1/M₂)Σ_{0≦λ≦M}_{₂}₋₁e^{j(2ππ+ω)ρ/M}^{₂}H₂(e^{j(2πλ+ω)/M}^{₂})

This suggests that the filter design problem for H₂(ez) can be reduced to another filter design problem, which is to design individual G_{ρ}(e^{jω}) for a given filter specification of H₂(e^{jω).}

FIG. 5C shows that the ideal response of H₂(e^{jω}), denoted Ĥ₂(e^{jω}), has the pass-band and stop-band constraints:

$$\begin{matrix}{\hat{H}}_{2} ( {e}^{jω} ) = {M}_{2} when \vert ω \vert < π / ( {M}_{1} {M}_{2} ) . \\ = 0 when \vert ω - 2 πλ / {M}_{2} \vert < π / ( {M}_{1} {M}_{2} )\end{matrix}$$

$$for λ = 1 , 2 , … , {M}_{2} - 1$$

and the value is unconstrained elsewhere (“don't care bands”).

Now applying scaling and translations to the frequency variable for the various values of λ gives for |ω|<π/M₁:

$$\begin{matrix}{\hat{H}}_{2} ( {e}^{j ( 2 π λ + ω ) / {M}_{2}} ) = {M}_{2} when λ = 0 , \\ = 0 when λ = 1 , 2 , … , {M}_{2} - 1\end{matrix}$$

and |ω|<π/M₁ corresponds to the don't care bands.

Then substituting this ideal Ĥ₂(e^{j(2πλ+ω)/M}^{₂}) into the foregoing equation for G_{ρ}(e^{jω}) gives the ideal response of G_{ρ}(e^{jω}), denoted Ĝ_{ρ}(e^{jω)}, as constrained:

Ĝ_{ρ}(e^{jω})=e^{jωρ/M}^{₂} for |ω|</M₁

That is, Ĝ_{ρ}(e^{jω})n acts as a fractional delay all-pass filter.

Prototype Design

There are two well-known ways to design the filters g_{ρ}(l) to approximate the ideal by minimizing the norm of the error ∥Ĝ_{ρ}(e^{jω)}−G_{ρ}(e^{jω}) ∥; namely, minimum mean squared error (MMSE) with the L² norm and minimax approximation with the L^{∞} norm. In both cases the minimization of the error reduces to a system of 2L linear equations for each value of ρ:

Ag_{ρ}=b_{ρ}

where, with the abbreviation f(x)=sin c(πx/M₁), the 2L×2L matrix A and the 2L-component vectors g_{ρ} and b_{ρ} for the MMSE case are:

$$A = [ \begin{matrix}f ( 0 ) & f ( 1 ) & … & f ( 2 L - 1 ) \\ f ( 1 ) & f ( 0 ) & … & f ( 2 L - 2 ) \\ ⋮ & ⋮ & ⋰ & ⋮ \\ f ( 2 L - 1 ) & f ( 2 L - 2 ) & … & f ( 0 )\end{matrix} ]$$

$${g}_{ρ} = [ \begin{matrix}{g}_{ρ} ( - L ) \\ {g}_{ρ} ( - L + 1 ) \\ ⋮ \\ {g}_{ρ} ( L - 1 )\end{matrix} ]$$

$${b}_{ρ} = [ \begin{matrix}f ( - L - ρ / {M}_{2} ) \\ f ( - L + 1 - ρ / {M}_{2} ) \\ ⋮ \\ f ( L - 1 - ρ / {M}_{2} )\end{matrix} ]$$

Analogously for the minimax case: the vector g_{ρ} is the same and the matrix A and vector b_{ρ} are, in terms of frequencies ω₁, ω₂, . . . , ω_{L} at which a selected (4L−1)-tap equi-ripple halfband filter with bandedge at π/M₁ has unity gain:

$$A = [ \begin{matrix}cos ( - L {ω}_{1} ) & … & cos ( ( L - 1 ) {ω}_{1} ) \\ - sin ( - L {ω}_{1} ) & … & - sin ( ( L - 1 ) {ω}_{1} ) \\ cos ( - L {ω}_{2} ) & … & cos ( ( L - 1 ) {ω}_{2} ) \\ - sin ( - L {ω}_{2} ) & … & \\ ⋮ & ⋰ & ⋮ \\ - sin ( - L {ω}_{L} ) & … & - sin ( ( L - 1 ) {ω}_{L} )\end{matrix} ]$$

$${b}_{ρ} = [ \begin{matrix}cos ( {ω}_{1} ρ / {M}_{2} ) \\ sin ( {ω}_{1} ρ / {M}_{2} ) \\ cos ( {ω}_{2} ρ / {M}_{2} ) \\ sin ( {ω}_{2} ρ / {M}_{2} ) \\ ⋮ \\ sin ( {ω}_{L} ρ / {M}_{2} )\end{matrix} ]$$

Then the filter coefficients are found as g_{ρ}=A⁻¹ b_{ρ}; and these coefficients only depend upon L, M₁, and M₂.

### 4. Two-Step Polynomial Approximation

So far, we have discussed well-known design methods for an oversampling filter, where the design problem was cast as solving a system of linear equations in the preceding section. By solving this system for each g_{ρ} with ρ=1, 2, . . . , M₂−1, we will obtain a total of 2LM₂ filter coefficients, which have to be stored in a ROM. In order to reduce the ROM size, the preferred embodiment methods approximate g_{ρ} with respect to the variable ρ by polynomials. From the preceding, it can be seen that A is independent of ρ; whereas, b_{ρ} depends upon ρ/M₂. If we can approximate each of the 2L components of the g_{ρ} by an N-th degree polynomial with respect to ρ, the total ROM size will be reduced from 2LM₂ filter coefficient as ROM entries to 2L(N+1) polynomial coefficients as ROM entries. Of course, the filter coefficients are computed from the polynomial coefficients and p values. For example, in the MMSE case, the first component polynomial approximation would be approximating sin c(π[−L−ρ/M₂]/M₁) as a function of the discrete variable ρ; that is, for each component a section of length π/M₁ of the graph of sin c is approximated by a polynomial.

Preliminarily, we normalize the variable ρ to x=ρ/M₂. Then we introduce a method that approximates the i-th component of b_{ρ}, which is written as bᵢ(x), for i=1, 2, . . . , 2L. Thus for the MMSE filter, the first component is b₁(x)=sin c((π(−L−x)/M₁); and for the minimax filter, b₁(x)=cos(ω₁x).

Then let qᵢ(x) denote the polynomial approximation of bᵢ(x) with

qᵢ(x)=Σ_{0≦n≦N}cₙ(i)xⁿ

where cₙ(i) are the polynomial coefficients. Obtain the polynomial coefficients using the least-square method as follows. Discretize x and determine K sample points xₖ, where k=1; 2; . . . ; K and 0≦xₖ<1. At each sample point, we calculate the target desired values bᵢ(xₖ). Then the least-square solution is given as

c(i)=(X^{T}X)⁻¹X^{T}bᵢ

where the vectors and matrix are

$$c ( i ) = [ \begin{matrix}{c}_{0} ( i ) \\ {c}_{1} ( i ) \\ ⋮ \\ {c}_{N} ( i )\end{matrix} ]$$

$${b}_{i} = [ \begin{matrix}{b}_{i} ( {x}_{1} ) \\ {b}_{i} ( {x}_{2} ) \\ ⋮ \\ {b}_{i} ( {x}_{K} )\end{matrix} ]$$

$$X = [ \begin{matrix}1 & {x}_{1} & … & {x}_{1}^{N} \\ 1 & {x}_{2} & & {x}_{2}^{N} \\ ⋮ & & & \\ 1 & {x}_{K} & … & {x}_{K}^{N}\end{matrix} ]$$

Note that K has to satisfy K>>N. Typically, K=M₂ and xₖ=k/M₂ is sufficient. After c(i) is calculated for i=1; 2; . . . ; 2L by using X, the polynomial oversampling filter can be obtained as follows.

$$\begin{matrix}{g}_{ρ} = [ \begin{matrix}{g}_{ρ} ( - L ) \\ {g}_{ρ} ( - L + 1 ) \\ ⋮ \\ {g}_{ρ} ( L - 1 )\end{matrix} ] \\ = {A}^{- 1} {b}_{ρ} \\ = {A}^{- 1} [ \begin{matrix}{b}_{1} ( ρ / {M}_{2} ) \\ {b}_{2} ( ρ / {M}_{2} ) \\ ⋮ \\ {b}_{2 L} ( ρ / {M}_{2} )\end{matrix} ] \\ = {A}^{- 1} [ \begin{matrix}{c}_{0} ( 1 ) & {c}_{1} ( 1 ) & … & {c}_{N} ( 1 ) \\ {c}_{0} ( 2 ) & {c}_{1} ( 2 ) & & {c}_{N} ( 2 ) \\ ⋮ & & & \\ {c}_{0} ( 2 L ) & {c}_{1} ( 2 L ) & & {c}_{N} ( 2 L )\end{matrix} ] [ \begin{matrix}1 \\ ρ / {M}_{2} \\ ⋮ \\ {( ρ / {M}_{2} )}^{N}\end{matrix} ] \\ = {A}^{′} [ \begin{matrix}1 \\ ρ / {M}_{2} \\ ⋮ \\ {( ρ / {M}_{2} )}^{N}\end{matrix} ]\end{matrix}$$

Thus the elements of the 2L×(N+1) matrix A′ are independent of ρ and are stored. Then the filter coefficients g_{ρ}(l) are approximated using A′. Section 5 below describes a direct polynomial approximation method for the MMSE case.

### 5. Direct Polynomial Approximation

An alternative polynomial approximation method for the polyphase filter coefficients g_{ρ}(l) in the MMSE case directly substitutes an N-th degree approximation polynomial, p_{ρ/M}_{₂}(l), for the g_{ρ}(l) in an error minimization, with

p_{ρ/M}_{₂}(l)=Σ_{0≦n≦N}cₗ(n)(ρ/M₂)ⁿ for l=−L, . . . , L−1, ρ=0, 1 . . . , M₂−1

The cₗ(n) are the polynomial coefficients for the approximation of g_{ρ}(l) and differ from the section 4 coefficients cₙ(l). which are for polynomial approximation of the b_{ρ}(l). Obtain the polynomial coefficients cₗ(n) by expressing the error norm in the frequency domain and minimizing with respect to each of the cₗ(n) by setting the partial derivatives of the squared error norm to 0; this gives 2L(N+1) equations for 2L(N+1) unknowns:

Σ_{-L≦l′≦L-1}Σ_{0≦n′≦N} sin c((l−l′)/M₁){Σ_{0≦ρ≦M}_{₂}₋₁(ρ/M₂)^{n+n′}}c_{l′}(n′)=Σ_{0≦ρ≦M}_{₂}₋₁(ρ/M₂)ⁿ sin c((l+ρ/M₂)π/M₁)

for n=0, . . . N and l=−L, . . . , L−1. The polynomial coefficients cₗ(n) can be calculated by solving this linear system.

In this case, a ROM stores the 2L(N+1) polynomial coefficients cₗ(n), and the polyphase filter coefficients, g_{ρ}(l), are approximated when needed for an output sample calculation by the polynomial as g_{ρ}(l)≈p_{ρ/M}_{₂}(l)=Σ_{0≦n≦N} cₗ(n)(ρ/M₂)ⁿ.

### 6. Sampling Rate Conversion

The sampling rate conversion use of the polyphase filter g_{ρ}(l) is explained as follows. When the time index m, at which an output sample is to be created, is determined, we map m to integer values n and ρ so that

m=nM₂+ρ where 0≦ρ<M₂

where n and ρ specify the input time index and polyphase index, respectively. Then the polyphase filter coefficients g_{ρ}(l) are calculated using the polynomial approximations of the preceding section. Finally, the output sample y(m) is calculated by using the polyphase filtering.

The preferred embodiment polynomial-approximated polyphase filter can also be used for infinite oversampling ratio or continuous time interpolation, where the output time index t can have fractional values. In this case, t is mapped to

t=T+τ where 0≦τ<1

where T and τ are the integer and fractional parts of t, respectively. The output sample y(t) is calculated by a modified version of the foregoing:

y(t)=Σ_{-L≦l≦L-1}s(T−l)g_{τ}(l)

where the coefficient g_{τ}(l) is computed from the l-th approximation polynomial with variable value equal to τ instead of ρ/M₂. That is, compute the output sample with coefficients g_{τ}(l)≈p_{τ}(l)=Σ_{0≦n≦N} cₗ(n)τⁿ.

In short, the oversampling rate conversion for a rational rate ratio has input samples y(iTₛ) where Tₛ is the input sampling period, and computes output samples ŷ(t) for times t=mTₛ/M where M is the oversampling ratio as follows.

(a) Oversample the input sample stream with a first stage oversampling ratio M₁ (for example, by 0 insertions and lowpass filtering or by other methods). Let y₁(jTₛ/M₁) denote these first stage oversamples which are stored in a FIFO buffer that is emptied during subsequent steps.

(b) Index map output sample time t by integers m(t)=k(t) M₂+ρ(t) where ρ=0, 1, . . . , M₂−1 and M₂=M/M₁; that is, t=m(t)Tₛ/M=k(t) Tₛ/M₁+(ρ(t)/M₂)Tₛ/M₁ where 0≦ρ(t)/M₂<1.

(c) Evaluate the 2L polynomial approximations (2L(N+1) polynomial coefficients cₗ(n) are stored in ROM) at ρ(t)/M₂ to give the filter coefficients p_{ρ/M}_{₂}(l) as

p_{ρ/M}_{₂}(l)=Σ_{0≦n≦N}cₗ(n)(ρ/M₂)ⁿ

where sets of N+1 of the polynomial coefficients correspond to polynomial approximations with respect to polyphase index (ρ=0, 1, . . . , M₂−1) for the length 2L polyphase filters constituting H₂ which is the lowpass filter for a second stage oversampling with ratio M₂.

(d) Compute the output sample at t as:

\hat{y}(t)=Σ_{-L≦l≦L-1}y₁((k−l)Tₛ/M₁)p_{ρ/M}_{₂}(l)

For output sampling times t which are not multiples of the oversampling points, find τ(t) so that t=k(t) Tₛ/M₁+τ(t)Tₛ/M₁ for k(t) an integer and 0≦τ(t)<1; and then evaluate the approximation polynomials at τ to get filter coefficients p_{τ}(l) as p_{τ(l)=Σ}_{0≦n≦N} cₗ(n)τⁿ for computation of the output sample as:

\hat{y}(t)=Σ_{-L≦l≦L-1}y₁((k−l)Tₛ/M₁)p_{τ}(l)

### 7. Experimental Results

The preferred embodiment polynomial-approximated second-stage oversampling filter was evaluated in the following condition. The oversampling ratio of the first stage oversamling filter M₁ was assumed to be M₁=4. Therefore, the input signal to the second stage oversampling filter was supposed to be cut-off at ¼ of the Nyquist frequency. Other conditions were chosen as follows.

Oversampling ratio M₂=32

Polyphase filter length 2L=6

Polynomial degree N=4

Under the above conditions, we generated the polynomial coefficients based on both the two-step method of section 4 and the direct method of section 5.

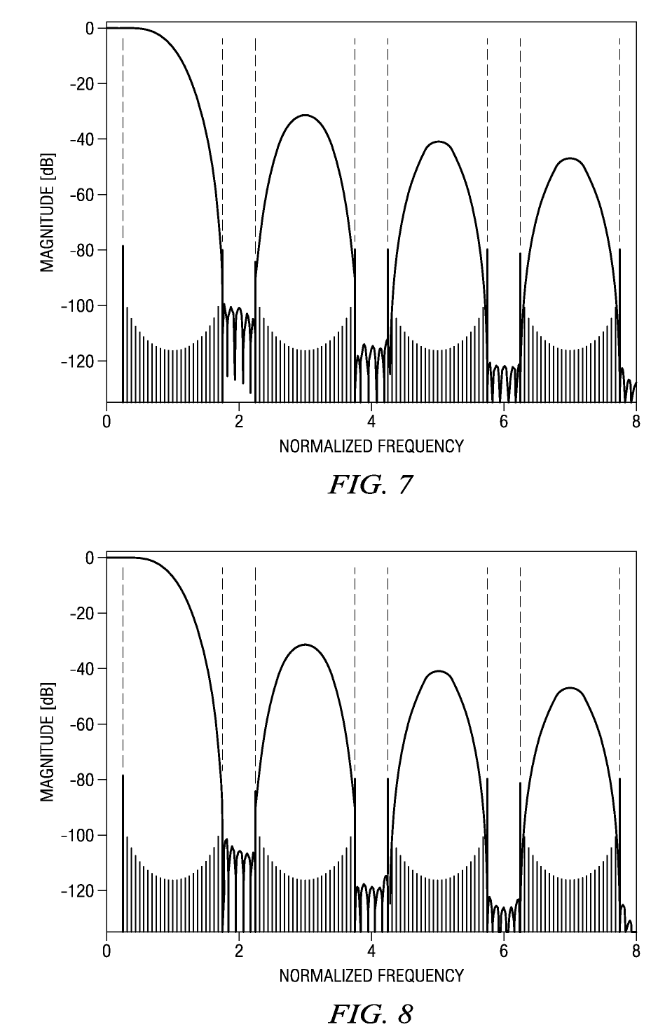

The frequency response of the designed filter is shown in FIGS. 7-8. The horizontal axis corresponds to the frequency normalized by the input Nyquist frequency. Just for evaluation purpose, we also designed an example first stage oversampling filter with cut-off frequency around 1/M₁=0.25, whose frequency response is shown in FIGS. 7-8 as dashed curves.

As explained in section 3, H₁(e^{jωM}^{₂}) exhibits peaks at multiple of the input sampling frequency, which have to be suppressed by the stop bands of the second stage oversampling filter. As can be seen in FIGS. 7-8, both of the preferred embodiment polynomial approximation methods exhibits sufficient stop-bands to suppress the peaks, while the direct method gives a slightly better suppression.

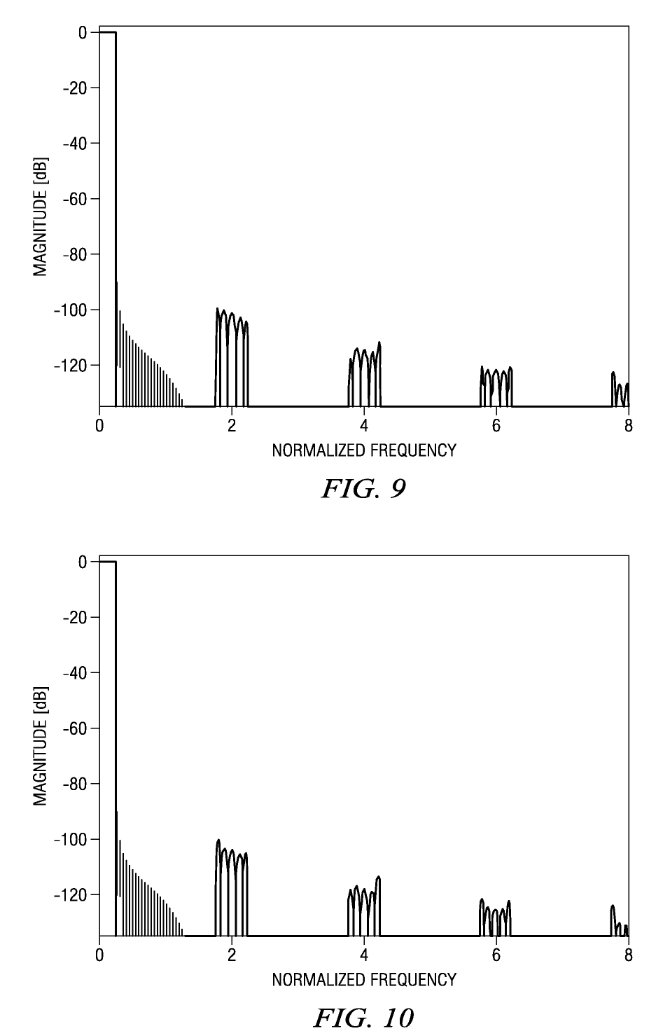

FIGS. 9-10 show the frequency response of the entire multistage oversampling filter response H(e^{jω}), which can be written as

H(e^{jω})=H₁(e^{jωM}^{₂})H₂(e^{jω})

As can be seen, H₁(e^{jωM}^{₂}) shows a low-pass characteristic with the worst case stop-band attenuation level at −100 dB.

The preferred embodiment filter design method was also tested for various oversampling ratio much larger than M₂=32. For the both (two-step and direct) methods, we confirmed that the worst case stop-band attenuation level stayed at −100 dB for any large oversampling ratio M₂. On the other hand, it is important note that computational costs and ROM size are independent of M₂. Therefore, under a certain design specifications regarding the first stage oversampling ratio M₁, polyphase filter length 2L, polynomial degree Nand stop band ripple, the preferred embodiment second stage oversampling filter allows any large oversampling ratio M₂ without any increase in computational cost nor ROM size. With this property, the preferred embodiment method is efficient for multistage oversampling filter systems that require huge oversampling ratios.

Comparison with Conventional Methods

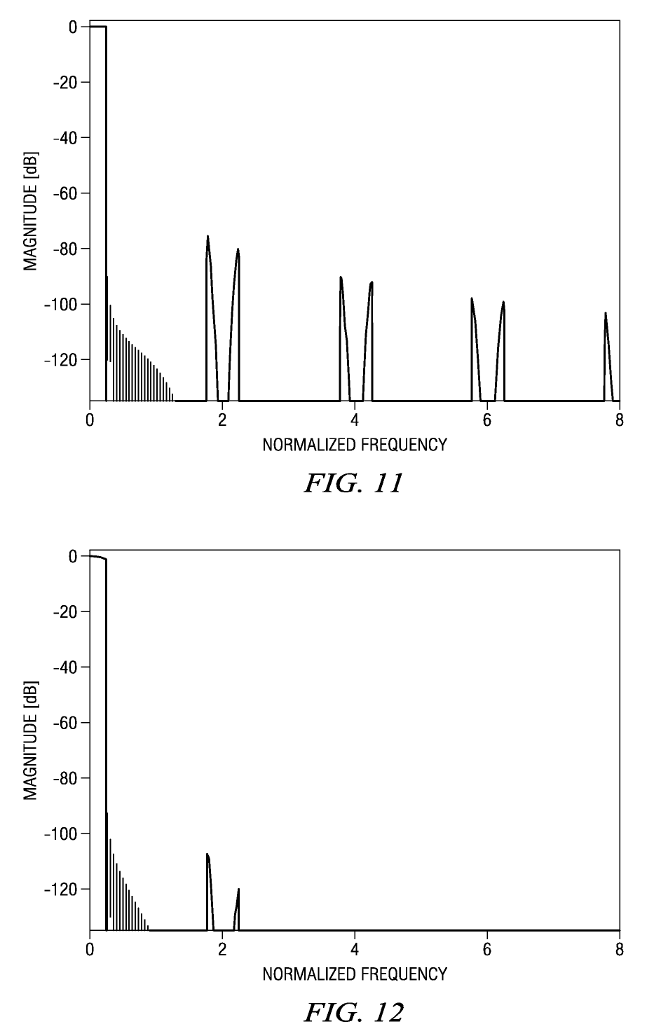

The performance of the proposed filter was compared with Lagrange and B-Spline interpolators, which are well-known conventional polynomial filters. Since the polynomial degree N of these filters are restricted to be N=2L−1, we let 2L=6 and N=5. The other conditions were chosen same as the previous section. We calculated the entire frequency response of H(e^{jω}) using the same first-stage oversampling filter shown in FIGS. 7-8. The results are shown in FIGS. 11-12. From FIG. 11, the Lagrange interpolator gives the worst-case stop-band attenuation level at only about −80 dB, which can be said inferior to the preferred embodiment filters. In FIG. 12, on the other hands, the B-Spline filter enables superior stop-band attenuation level (about −108 dB) to the preferred embodiment filters. However, it can also be seen that the B-Spline filter causes droop in the pass-band. It was confirmed that the B-Spline filter lowers the pass-band gain to −1.1 dB at 1/M₁=0.25 of normalized frequency. Such droop is not found for the preferred embodiment methods, since the approximation process both controls the pass-band and the stop-bands.

It is also noted that, with these conventional methods, the stop-band width and stop-band attenuation level are determined uniquely once the filter length 2L (and therefore the degree N) is given. Contrarily, the preferred embodiment design methods allow flexibility to control the trade-off regarding stop-bands (narrower the bandwidth, better the attenuation). This is another benefit in using the preferred embodiment polynomial filter design. Furthermore, the preferred embodiment methods provide full flexibility of choosing the filter length L and the polynomial degree N independently unlike the Lagrange and B-Spline type polynomials.

8. Improvement with Pass-Band Droop

The previous section indicated that the B-Spline filter gives better stop-band attenuation, while it suffers from droop in the pass-band. Having droop in the second stage oversampling filter can be acceptable in the case where the first stage oversampling filter is capable of compensating for the droop. If this is the case, we can improve the stop-band attenuation level of the second stage polynomial filter by allowing its pass-band to have droop.

Modified Polyphase Filter Specification for Droop

To enable droop, we only have to modify the specification of the second stage filter response Ĥ₂(e^{jω}) to have

$$\begin{matrix}{\hat{H}}_{2} ( {e}^{jω} ) = {M}_{2} W ( ω ) when \vert ω \vert < π / ( {M}_{1} {M}_{2} ) . \\ = 0 when \vert ω - 2 πλ / {M}_{2} \vert < π / ( {M}_{1} {M}_{2} )\end{matrix}$$

$$for λ = 1 , 2 , … , {M}_{2} - 1$$

where W(ω), 0≦W(ω)≦1, corresponds to the droop curve. Typically, W(0)=1 and W(π/(M₁M₂) is the droop level at the pass-band edge. Thus the ideal polyphase filter response is modified to

Ĝ_{ρ}(e^{jω})=W₂(ω)e^{jωρ/M}^{₂} for |ω|<π/M₁

where W₂(ω)=W(ω/M₂). Noting that W₂(0)=1 and W₂(π/M₁) is the droop level at the pass-band edge.

Polynomial Coefficient Based on the Direct Approximation Method

The new polyphase filter specification with droop can easily be adopted to the direct method (explained in section 5) for finding approximation polynomial coefficients. In particular, the p-th error component in the frequency domain P_{ρ}(e^{jω})−e^{jωρ/M}^{₂} is replaced by P_{ρ}(e^{jω})−W₂(ω)e^{jωρ/M}^{₂}. This changes the linear system for the coefficients cₗ(n) into

$${\sum }_{- L \leq {l}^{′} \leq L - 1} {\sum }_{0 \leq {n}^{′} \leq N} sin c ( ( l - {l}^{′} ) π / {M}_{1} ) \{ {\sum }_{0 \leq ρ \leq {M}_{2} - 1} {( ρ / {M}_{2} )}^{n + {n}^{′}} \} {c}_{{l}^{′}} ( {n}^{′} ) == {\sum }_{0 \leq ρ \leq {M}_{2} - 1} {( ρ / {M}_{2} )}^{n} S ( l + ρ / {M}_{2} )$$

where S(l+ρ/M₂)=∫_{-π/M}_{₁}_{≦ω≦π/M}_{₁} W₂(ω) cos(xω) dω. Of course, for W₂(ω)=1, this reduces to the previous S(l+ρ/M₂)=sin c((l+ρ/M₂)π/M₁).

Design Example and Result

We evaluated the approximation polynomial filter under the same condition as previously. We let W₂(ω)=1.0−0.12ω². Therefore, the target droop level at the pass-band edge is calculated to be

20 log(1.0−0.12(π/M₁)²)=−0.67dB

which is smaller droop than that of the B-Spline filter which can go down to −1 dB.

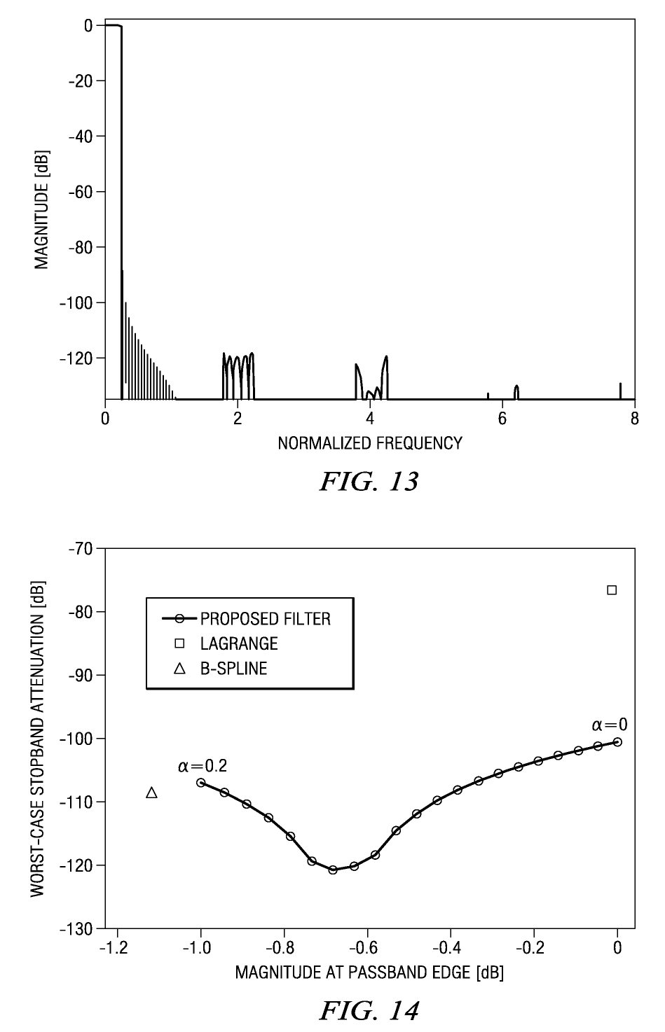

We calculated H(e^{jω}) using the same first stage oversampling filter as those in FIGS. 7-8. The obtained frequency response is shown in FIG. 13. As can be seen, the stop-band attenuation level is improved to −118 dB.

FIG. 14 shows the effect of the droop amount. The droop curve was given to be W₂(ω)=1.0−αω², and the pass-band edge level and worst-case stop-band attenuation level of the resulting filter were observed for α=0, 0.01, 0.02, . . . , 0:2. It can be seen that the attenuation level can go down to −120 dB at α=0.14 with pass-band edge level at −0.7 dB.

FIG. 14 illustrates the advantage of the preferred embodiment filter design over the conventional polynomial interpolators. The preferred embodiment filter provides better stop-band attenuation than the Lagrange interpolator regardless of droop. When the droop is acceptable, the preferred filter with an optimal choice of the droop factor α provides better stop-band attenuation than the B-Spline interpolator with smaller droop.

What is claimed is:

1. A method of sampling rate conversion, comprising the steps of:
(a) providing input sample stream x(iTₛ) where i is an integer and Tₛ is the input sampling period;
(b) oversampling said input sample stream with a first stage oversampling ratio M₁ to give first stage oversamples s(jTₛ/M₁) where j is an integer;
(c) mapping an output sample time t as t=k(t) Tₛ/M₁+τ(t)Tₛ/M₁ where k(t) is an integer which depends upon t and 0≦τ(t)<1;
(d) computing 2L filter coefficients p_{τ(t)}(l) for l=−L, . . . , L−1 where L is a positive integer by
p_{τ(t)}(l)=Σ_{0≦n≦N}cₗ(n)τ(t)ⁿ.
where coefficients cₗ(n) for N a positive integer are polynomial approximations for the length 2L polyphase filters constituting a lowpass filter for a second stage oversampling with oversampling ratio M₂; and
(e) computing an output sample for said time t as:
y(t)=Σ_{-L≦l≦L-1}s((k−l)Tₛ/M₁)p_{τ(t)}(l).

2. A method of sampling rate conversion, comprising the steps of:
(a) providing an input sample stream x(iTₛ) where i is an integer and Tₛ is the input sampling period; and
(b) computing an output sample for a time t as:
y(t)=Σ_{-L≦l≦L-1}s((k−l)Tₛ/M₁)p_{τ(t)}(l).
where t=k(t) Tₛ/M₁+τ(t)Tₛ/M₁ with k(t) an integer, 0≦τ(t)<1, and M₁ is a first oversampling ratio; where s(jTₛ/M₁) with j an integer are oversamples of said input x(jTₛ) by said first oversampling ratio; and where coefficients p_{τ(t)}(l) for l=−L, . . . L−1 with L a positive integer are given by:
p_{τ(t)}(l)=Σ_{0≦n≦N}cₗ(n)τ(t)ⁿ.
with coefficients cₗ(n) for n=0, 1, . . . , N and N a positive integer where for each l the cₗ(n) are coefficients of a polynomial approximation for the l-th coefficients of length 2L polyphase filters constituting a lowpass filter for an oversampling with a second oversampling ratio equal to M₂.

3. The method of claim 2, wherein said cₗ(n) are solutions of the linear equations:
$${\sum }_{- L \leq {l}^{′} \leq L - 1} {\sum }_{0 \leq {n}^{′} \leq N} sin c ( ( l - {l}^{′} ) π / {M}_{1} ) \{ {\sum }_{0 \leq ρ \leq {M}_{2} - 1} {( ρ / {M}_{2} )}^{n + {n}^{′}} \} {c}_{{l}^{′}} ( {n}^{′} ) == {\sum }_{0 \leq ρ \leq {M}_{2} - 1} {( ρ / {M}_{2} )}^{n} sin c ( ( l + ρ / {M}_{2} ) π / {M}_{1} )$$
for n=0, 1, . . . N, ρ=1, 2, . . . , M₂−1, and l=−L, . . . , L−1.

4. The method of claim 2, wherein said cₗ(n) are solutions of the linear equations:
$${\sum }_{- L \leq {l}^{′} \leq L - 1} {\sum }_{0 \leq {n}^{′} \leq N} sin c ( ( l - {l}^{′} ) π / {M}_{1} ) \{ {\sum }_{0 \leq ρ \leq {M}_{2} - 1} {( ρ / {M}_{2} )}^{n + {n}^{′}} \} {c}_{{l}^{′}} ( {n}^{′} ) == {\sum }_{0 \leq ρ \leq {M}_{2} - 1} {( ρ / {M}_{2} )}^{n} S ( l + ρ / {M}_{2} )$$
for n=0, 1, . . . N, ρ=0, 1, 2, . . . , M₂−1, l=−L, . . . , L−1, and
S(l+ρ/M₂)=∫_{-π/M}_{₁}_{≦ω≦π/M}_{₁}W₂(ω)cos(xω)dω
where W₂(ω) is a droop function with W₂(ω)=1.

5. The method of claim 2, wherein said cₗ(n) are components of a 2L×(N+1) matrix computed from minimization of a norm of an approximation error for said p_{τ(t)}(l) wherein said norm is selected from the group consisting of L² norm and L^{∞} norm.

6. In a sampling rate conversion method of the type that oversamples an input digital sample stream x(iTₛ) by a factor of M to get oversamples x_{M}(jTₛ/M), and then computes an output sample for time t as:
y(t)=Σ_{-J≦j≦J-1}x_{M}(jTₛ/M)K(tM/Tₛ−j).
where K( ) is a B-spline finite-duration kernel which approximates sin c( );
the improvements of:
(a) performing oversampling in two stages with oversampling ratios M₁ and M₂=M/M₁; and
(b) computing the output sample for said time t as:
y(t)=Σ_{-L≦1≦L-1}s((k−l)Tₛ/M₁)p_{τ(t)}(l).
where t=k(t) Tₛ/M₁+τ(t)Tₛ/M₁ with k(t) an integer and 0≦τ(t)<1; where s(jTₛ/M₁) with j an integer are oversamples of said input x(jTₛ) by said oversampling ratio M₁; and where coefficients p_{τ(t)}(l) for l=−L, . . . , L−1 with L a positive integer are given by:
p_{τ(t)}(l)=Σ_{0≦n≦N}cₗ(n)τ(t)ⁿ.
with coefficients cₗ(n) for n=0, 1, . . . , N and N a positive integer less than M₂ where for each l the cₗ(n) are coefficients of a polynomial approximation for the l-th coefficients of length 2L polyphase filters constituting a lowpass filter for oversampling with said oversampling ratio M₂.
